(19) United States
(12) Patent Application Publication
(10) Pub. No.: US 2007/0011141 A1
(43) Pub. Date: Jan. 11, 2007

(54) Method and system for augmenting a physical artifact with a digital story

(76) Inventors: Brooke Foucault, Hillsboro, OR (US); Ryan S. Russell, Hillsboro, OR (US)

Correspondence Address: BUCKLEY, MASCHOFF, TALWALKAR LLC, 50 LOCUSTAVENUE, NEW CANAAN, CT, 06840, US

(21) Appl. No.: 11/171,751

(22) Filed: Jun. 30, 2005

(51) Int. Cl. G06F 17/30

(52) U.S. Cl. 707/3

(57) ABSTRACT

According to some embodiments, a method includes monitoring a local vicinity of a memory capture device for a presence of a physical object or an occurrence of a threshold physical event, detecting the presence of the physical object or the occurrence of the threshold physical event, automatically capturing and storing information from the local vicinity of the capture device in an electronic file, the electronic file including at least one of image, video, and audio data types.

### BACKGROUND

A person may remember an occurrence of a physical event. Such a remembrance may be referred to as a memory. In some instances, a memory may be associated with a physical object. However, a person's memory may fail over time, be inaccurately recalled, or lost forever, for example, upon the death of the person possessing the memory. In an attempt to preserve a memory, some types or aspects of an occurrence of a physical event may be recorded in an electronic file for future recall thereof.

However, storing and recalling recorded electronic files for playback thereof may require a user to, for example, actively create the electronic file, know the name of the file, actively search and/or retrieve the file, and arrange to playback the file.

### BRIEF DESCRIPTION OF THE DRAWINGS

FIG. 1 is an exemplary flow diagram of a method, according to some embodiments hereof;

FIG. 2 is an exemplary flow diagram of a method, according to some embodiments hereof;

FIG. 3 is an exemplary flow diagram of a method, according to some embodiments hereof;

FIG. 4 is an exemplary flow diagram of a method, according to some embodiments hereof;

FIG. 5 is an exemplary flow diagram of a method, according to some embodiments hereof; and

FIG. 6 is an exemplary system, according to some embodiments herein.

### DETAILED DESCRIPTION

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

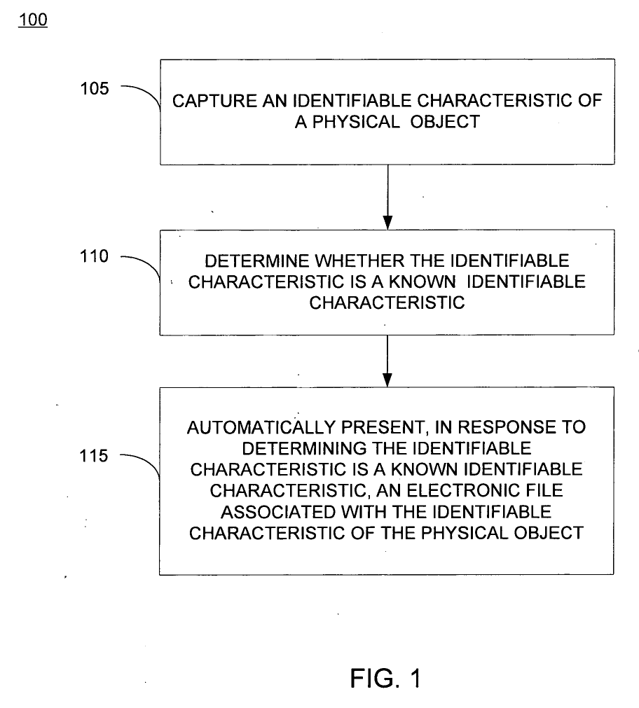

FIG. 1 provides an exemplary flow diagram of a process 100, used in some embodiments herein, to associate a physical object with an electronic file. In some embodiments, the electronic file can include a number of aspects of a story or memory. Some aspects of the memory to associate with the physical object may include multimedia data. For example, the electronic file can include an image such as a photograph, a video clip, a textual description or story, and combinations thereof to associate with the physical object. At operation 105, an identifiable characteristic of a physical object is captured. The physical object may be any object having a physical form. For example, the physical object may be a stuffed animal, a hardcopy of a photograph, an autographed theater program, a baseball card, an article of jewelry, etc.

The identifiable characteristic of the physical object, in some embodiments, can uniquely identify the physical object. For example, the physical object may be identified as particular stuffed toy brown teddy bear, toy purple giraffe, solitaire diamond ring having an emerald cut stone, etc. In some embodiments, the identifiable characteristic may identify a class or type of object to which the physical object belongs. For example, the physical object may be generally identified as a stuffed animal, a baby rattle, jewelry, a ball, a book, a dog, a cat, etc.

Regarding the capture of the identifiable characteristic of the physical object of operation 105, the particular devices and methods used to capture the identifiable characteristic of the physical device may vary depending on the physical objects that are to be identified at operation 105. For example, the capture device and method may include a digital camera having a charge coupled device (CCD), an infrared camera, an optical scanner, an x-ray device, a scale, a heat sensor, a weight sensor, a moisture sensor, a temperature sensor, a motion sensor, a microphone, an identifying indicia reader (e.g., bar code reader), an electrical transmission reader, (e.g., radio frequency identification, RFID, tag receiver), and combinations of these and other identity capture devices and techniques.

The identifiable characteristic may include one or more attributes of the physical object that identify the physical object, either uniquely or generally. By way of example, the captured identifiable characteristic may include at least one of a weight, a length, a density, a visual or optical recognizable feature, a temperature, a shape, a composition, identifying indicia, an electrical transmission, and any combinations thereof. It should be appreciated that combinations of these, additional, fewer, or alternative captured identifiable characteristics of the physical object may be used in combination or isolation to identify the physical object with varying degrees of specificity.

At operation 110, a determination is made whether the identifiable characteristic is a known characteristic. In some embodiments, an identifiable characteristic is considered “known” when the identifiable characteristic is known to method 100, method 100 is aware of a pre-existing instance of the identifiable characteristic, and/or the identifiable characteristic is known to a system implementing some embodiments of the methods herein. For example, the identifiable characteristic captured at operation 105 may be compared to a number of identifiable characteristics stored or accessible by a device, apparatus, or system implementing method 100. In some embodiments, the identifiable characteristic captured at operation 105 may be compared to a number of stored or accessible pre-existing, i.e., known, identifiable characteristics.

The known identifiable characteristics may be stored in a memory device or mechanism such as, for example, a hard disk drive, RAM memory (random access memory), a DVD, a CD-ROM, and removable memory devices such as compact flash, secure digital, smart media, multimedia card, memory stick, microdrive, portable USB (universal serial bus) drive, floppy disk, and the like. It should be appreciated that current and future developed memory and storage devices, mechanisms, and methods may be used to store an identifiable characteristic of the physical object, in accordance with some embodiments herein.

In the instance it is determined at operation 110 that the captured identifiable characteristic is a known identifiable characteristic, process 100 proceeds to operation 115. At operation 115, an electronic file is automatically presented in response to the determination that the captured identifiable characteristic is a known identifiable characteristic. In some embodiments, to automatically present the electronic file includes a process or operation that automatically invokes or at least initiates a presentation of the electronic file. That is, for example, a user, administrator, person, application, or other entity need not perform an action to present the electronic file or initiate a presentation of the electronic file.

In some embodiments, presentation of the electronic file may include presenting at least portions of the electronic file on a display device (e.g., a video monitor or other graphic display device), an audio output device (e.g., a speaker), a printer, and other audio-visual sensory devices (e.g., a vibrating device, etc.). In some embodiments, the presentation of the electronic file may include transferring the electronic file to a device or person for presentation. For example, the presenting of operation 115 may include sending a message of the electronic file to, for example, a display device, a message server, or other device or application.

In some embodiments herein, the electronic file may include more than one type of data content therein. For example, the electronic file may include at least one of audio, still images, video, textual data, and combinations thereof. It should be appreciated that the data structures, formats, protocols, and size of the electronic file and the data types therein may vary to include any number of electronic file data structures, formats, protocols, and sizes.

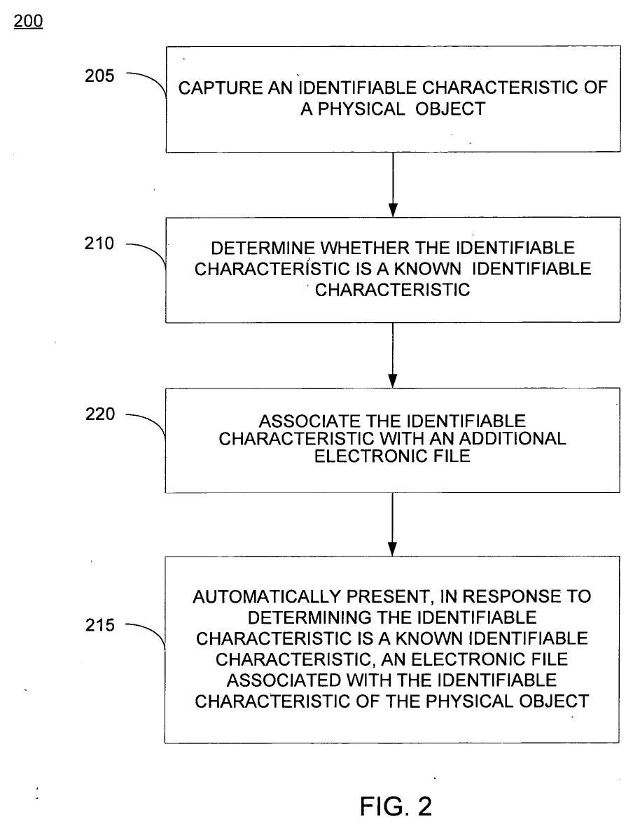

Referring to FIG. 2 and some embodiments thereof, operations 205, 210, and 215 are similar to operations 105, 110, and 115 of FIG. 1. Accordingly, a detailed discussion of operations 205, 210, and 215 is not provided, rather reference should be made to operations 105, 110, and 115. In some embodiments, process 200 may include an operation 220 to associate a captured identifiable characteristic with an electronic file. This operation may be invoked, for example, in an instance the determination of operation 210 indicates that the captured identifiable characteristic is not known. Accordingly, the physical object is identified by an unknown (i.e., new) identifiable characteristic, as determined at operation 210, and is further associated with an electronic file at operation 220.

Operation 220 to associate the captured identifiable characteristic with an electronic file may occur prior to, concurrent with and/or after, for example, operation 215. In some embodiments, operation 220 to associate a physical object (as identified by the captured identifiable characteristic) with an electronic file may be used to associate the physical object with an electronic file in an initial or first instance of associating the physical object with an electronic file. In some embodiments, operation 220 to associate a physical object with an electronic file may be used to associate the physical object with an additional or modified electronic file after an initial or first instance of associating the physical object with an electronic file. Accordingly, a physical object may be identified in operations 205 and 210, associated with an electronic file at operation 220 that is automatically presented in response to the identification at operation 215.

In some embodiments, the electronic file that is associated with the physical object is created as part of, for example, process 200. It should be appreciated that the creation of the electronic file may be accomplished according to a number and variety of methods and techniques to include the variety of data types discussed and contemplated herein, without departing from the scope of the present disclosure.

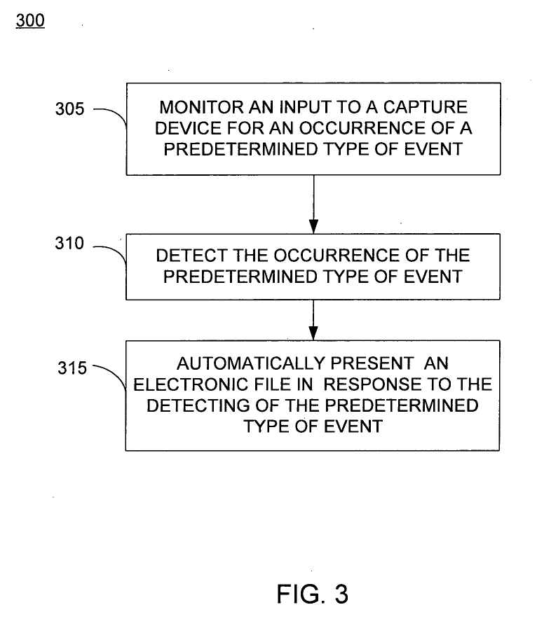

Referring to FIG. 3, an exemplary flow diagram of a process to automatically present an electronic file in response to a detection of an event is illustrated, generally represented by reference number 300. Process 300 includes a first operation 305 that monitors an input to a capture device for an occurrence of a predetermined type of event. The capture device referenced at operation 305 may include any number of types of capture devices that are capable of capturing audio, image, video, motion, and other attributes of a event. In some embodiments, the capture device may be capable of additionally or alternatively capturing an occurrence of text input, motion, electrical transmission, timing events, meteorological data, combinations thereof, and other types of event attributes or characteristics. In some embodiments, there may be a number of other types of inputs, such as but not limited to, ambient noise levels, specific key words (recognized using voice recognition), detected vibrations, a temperature, movement of a specific object, and other events. The text data may include, for example, a data record of a schedule or calendar information. The data record of the schedule or calendar information may include an indication of specific dates and events such as, for example, a birthday, an appointment, an anniversary, and other occurrences that may be indicated in a calendar application.

In some embodiments, a particular sequence of audio, image, video, motion, text, motion, electrical transmission, timing events, meteorological data, combinations thereof, and other types of event attributes or characteristics may indicate the occurrence of an event of a particular predetermined event. There may be a number of predetermined events relevant to process 300. Some embodiments of predetermined events may include, for example, a sequence of sounds and/or images, video, and motions that may be indicative of a person crying, laughing, talking joyfully, talking soothingly, or in the presence of the capture device, a presence of an animal (e.g., a family pet, a stray, or a pest), dawn, dusk, day, night, a meteorological event (e.g., a rainstorm, a snowstorm, lightening, thunder, etc.), a presence of a electrical signal transmitting device (e.g., a RFID tag), and combinations thereof. An input to the capture device may also include, in some embodiments, a news feed of various news events. The receipt of news of, for example, an impending weather warning, may be considered a predetermined event in accordance with method 300. Other types of news events may be considered a predetermined type of event as well.

At operation 310, the occurrence of the predetermined type of event referenced at operation 305 is detected. That is, operation 310 includes detecting the occurrence of the predetermined type of event at the input of the capture device. Accordingly, the capture device may capture at least a portion of the predetermined event.

At operation 315, an electronic file is automatically presented in response to the detection of the predetermined type of event. In the instance the predetermined type of event is detected at operation 310, an electronic file is automatically presented in response to such detecting at operation 315. In some embodiments, the automatic presentation of the electronic file may include presenting at least portions of the electronic file on a display device (e.g., a video monitor or other graphic display device), an audio output device (e.g., a speaker), a printer, and other audio-visual sensory devices (e.g., a vibrating device, etc.). In some embodiments, automatic presentation may include transferring the electronic file to a device, application or person for presentation. For example, operation 315 may include sending a message of or including the message to, for example, a display device.

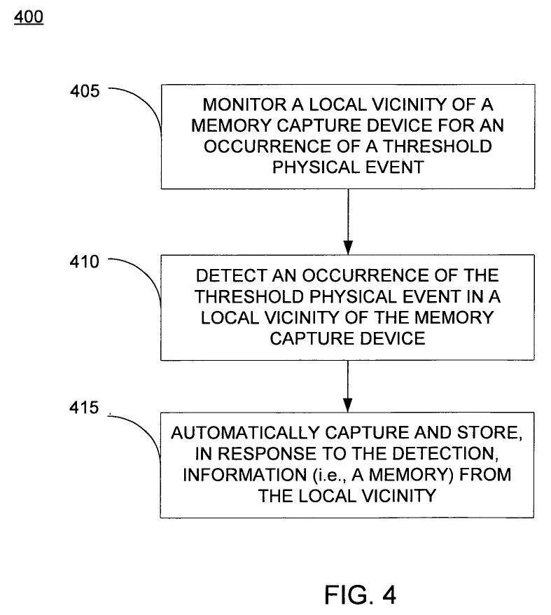

FIG. 4 illustrates a process 400 to capture information from a local vicinity of a capture device and to store the information in an electronic file. In some embodiments hereof, an operation 405 monitors a local vicinity of a captured device for an occurrence of a threshold physical event. The extent of the local vicinity monitored can be set to a fixed range of area, dynamically adjusted to a range of area, and/or based on the area that can be monitored by the capture device. The capture device may include, for example, a camera, an infrared camera, an optical scanner, an x-ray device, a scale or weight sensor, a heat sensor, a moisture sensor, a motion detector, a microphone, an identifying indicia reader (e.g., bar code reader), an electrical transmission reader, (e.g., radio frequency identification tag receiver), combinations thereof, and combinations with other physical event capture devices and techniques.

The physical event monitored for by the capture device may include one or more physical aspects or attributes of an occurrence of a physical event. In some embodiments, the physical event may include at least one physical aspect or attribute of an occurrence of an event that may be monitored by the capture device. As an example, the monitored for physical event may include, in some embodiments, a sound, a motion, a temperature change or fluctuation, electrical (e.g., electro-magnetic, RF) transmissions indicative of a physical event (presence of a person or animal), a meteorological event (e.g., wind, rain, snow, etc.), combinations of these and other types of physical events. At operation 410, the occurrence of the threshold physical event monitored by the capture device is detected. Operation 410 may include, in some embodiments, some level of processing, analysis, or comparison to determine whether a detected occurrence of physical activity is a threshold physical activity. Criteria used, if any, to determine whether the detected occurrence of a physical event may be based on factors such as an amplitude, a quantity, a frequency, and other metrics of the detected occurrence of the physical event. For example, a detected small motion in the vicinity of a motion detector capable capture device may not qualify as a detected occurrence of a threshold physical event whereas a detected motion sustained for at least 10 seconds may qualify as a detected occurrence of a threshold physical event.

A threshold level of the occurrence of the physical event may be used to, for example, capture significant physical events. In some embodiments, the threshold level for the occurrence of the physical event may be a minimum or at least a lower level occurrence of the physical event attribute that is monitored for and detected by process 500. In some embodiments, the threshold level of the physical event may be expressed as a range of measurable values. For example, in an instance the physical event is a sound, the threshold physical event may be a sound above a minimum level or a sound that is sustained for a minimum duration of time. In an instance the physical event is a movement in the local vicinity of the capture device, the threshold physical event may be a motion of a minimum range or a motion sustained for a minimum duration of time.

At operation 415, in response to the detection of the occurrence of the threshold physical event at operation 410, process 400 automatically captures and stores information from the local vicinity of the capture device. The captured and stored information may be referred to herein as a memory. The captured and stored information may relate to and further include aspects of the detected occurrence of the threshold physical event. In some embodiments, to automatically capture and store the information includes a process or operation that automatically invokes or at least initiates a capturing and storing of information from the local vicinity in an electronic file. That is, for example, a user, administrator, person, application, or other entity need not perform an action to initiate or accomplish the capturing and storing of the information in the electronic file.

In some embodiments herein, the capture device may be concealed, connected to, or integrated with another device. In some embodiments, the capture device may by substantially camouflaged or concealed in the other device, in a substantially unobtrusive manner. The concealment or integration of the capture device with the other device may facilitate an efficient capture of memories (e.g., physical events) for storage in an electronic file, including some embodiments herein where the capturing, storing, and presenting of an electronic file may be performed automatically. For example, the capture device may be concealed, camouflaged, and/or integrated with an inanimate object such as a picture frame, a toy, an article of furniture, etc.

It should be appreciated that, in some embodiments, further processing, transferring, and manipulation may be performed on the information captured and stored at operation 415. For example, an automatic presentation of the captured and stored information of operation 415 may be provided, including presentation operations similar to the automatic presentation operations discussed above regarding operations 115, 215, and 315.

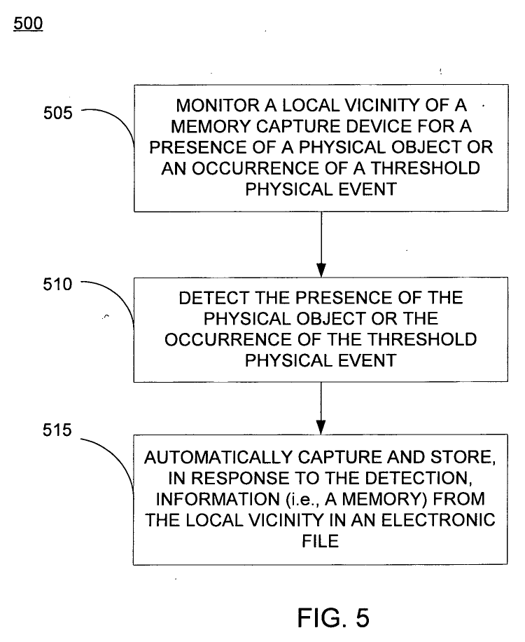

FIG. 5 is an exemplary process 500 to capture information from a local vicinity of a capture device and store the information in an electronic file. In some embodiments hereof, an operation 505 monitors a local vicinity of a captured device for a presence of a physical object or an occurrence of a threshold physical event or. Accordingly, process 500 may include some aspects of the operations mentioned hereinabove with regard to FIGS. 1-4. That is, some aspects of process 500 may be accomplished, for example, using some of the methods and operations discussed herein regarding FIGS. 1-4.

At operation 510, the presence of the physical object or the occurrence of the threshold physical event monitored by the capture device is detected. The detecting of operation 410 may include, in some embodiments, some level of processing, analysis, or comparison to determine a detected occurrence of the physical object or whether the physical activity is a threshold physical activity. Criteria used, if any, to determine the detected occurrence of a physical object or a physical event may vary.

At operation 515, in response to the detection of the presence of the physical object or the occurrence of the threshold physical event at operation 510, process 500 automatically captures and stores information from the local vicinity of the capture device. The captured and stored information may relate to and further include aspects of the detected occurrence of the threshold physical event or the physical object. In some embodiments, to automatically capture and store the information includes a process or operation that automatically invokes or at least initiates a capturing and storing of information from the local vicinity in an electronic file.

In some embodiments, further processing, transferring, and manipulation may be performed on the information captured and stored at operation 515.

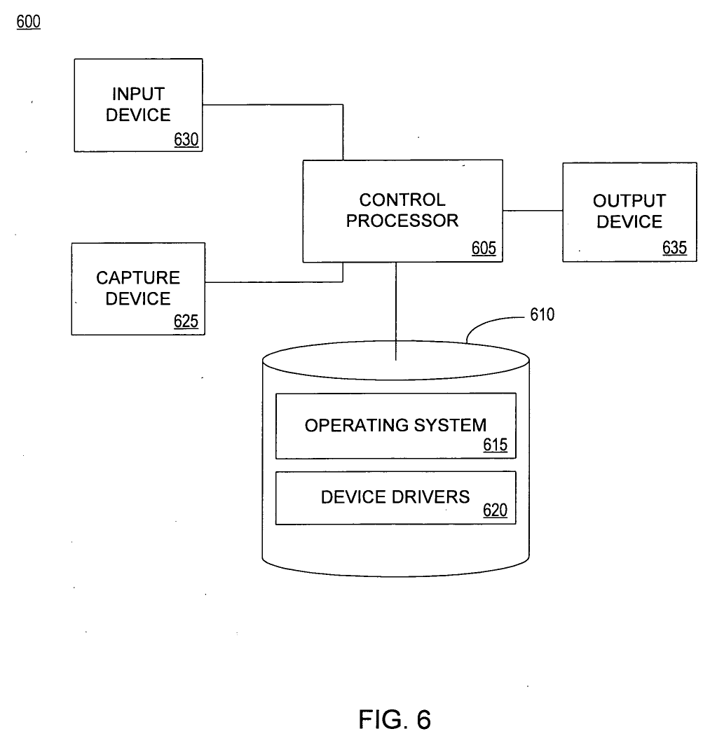

FIG. 6 is a block diagram of a system 600 according to some embodiments hereof. System 600 may comprise components of a desktop computing platform. System 600 includes a processor 605, a memory 610, a capture device 625, an input device 630, and an output device 635. Those in the relevant art should appreciate that system 600 may include additional, fewer, or alternative components to those depicted in FIG. 6.

Processor 605 may be or include any number of processors, which may be any type or configuration of processor, microprocessor, and/or micro-engine that is or becomes known or available. In some embodiments, other electronic and/or electrical devices may be utilized in place of or in addition to processor 605. According to some embodiments, processor 605 may be an Pentium® Processor or an XScale® Processor such as an Intel® PXA270 XScale® processor. Memory 610 may be or include, according to some embodiments, one or more magnetic storage devices, such as hard disks, one or more optical storage devices, and/or solid state storage. Memory 610 may store, for example, an operating system 615, a device driver 620, applications, programs, procedures, and/or modules that store instructions to be executed by processor 605. Operating system 615 may provide a software platform on which other programs may run and perform such tasks as recognizing input from input device 630 (e.g., a keyboard, a mouse), sending output to output device 635 (e.g., a display screen), keeping track of files and directories, and controlling peripheral devices such as capture device 625. Device drivers 620 may act like a translator between a device (e.g., capture device 625, input device 630, and output device 635) and programs that use the device. In some embodiments, the device drivers 620 may be included as part of operating system 615

Memory 610 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

In some embodiments, microprocessor 605 may control an operation or sequence of operation of capture device 625, including capturing an aspect of a physical event or a physical object. Processor 605 may control, for example, activation; a sequence of operation, including responsive actions; and durations of operation. Processor 605 may control operational aspects of input device 630 and output device 635.

Memory 610 may store instructions, that when executed by processor 605, effectuate the methods of the present disclosure. The instructions may be part of a program, application, operating system, applet, routine provided on a central, distributed, removable memory storage device or any other arrangement of instructions executable by processor 605. The methods implemented by system 600 may include the methods discussed herein, including, for example, the methods of FIGS. 1-5.

The several embodiments described herein are solely for the purpose of illustration. Persons in the art will recognize from this description that other embodiments may be practiced with modifications and alterations, limited only by the claims.

What is claimed is:

1. A method comprising:
capturing an identifiable characteristic of a physical object by a capture device;
determining whether the identifiable characteristic of the physical object is a known identifiable characteristic; and
in response to the determining indicating the identifiable characteristic is a known identifiable characteristic of the physical object, automatically presenting an electronic file associated with the physical object, the electronic file including at least one of audio, video, and graphic image data types.

2. The method of claim 1, further comprising associating the identifiable characteristic with the electronic file in response to the determining indicating the identifiable characteristic is not a known identifiable characteristic of the physical object.

3. The method of claim 1, further comprising associating the identifiable characteristic with an additional electronic file that includes at least one of audio, video, and graphic image data types.

4. The method of claim 1, further comprising creating the electronic file.

5. The method of claim 1, wherein the identifiable characteristic of the physical object is least one of a weight, a length, a density, a visual or optical recognizable feature, a temperature, a shape, a composition, identifying indicia, an electrical transmission, and any combinations thereof.

6. The method of claim 1, wherein the presenting comprises at least one of visually displaying, printing, messaging, and audibly presenting the electronic file.

7. A method comprising:
monitoring an input to a capture device for an occurrence of a predetermined type of event;
detecting the occurrence of the predetermined type of event; and
automatically presenting an electronic file in response to the detecting, the electronic file including at least one of audio, video, and graphic image data types.

8. The method of claim 7, further comprising determining whether the detected occurrence of the predetermined type of event is associated with the electronic file.

9. The method of claim 7, wherein the capture device comprises at least one of a camera device, a temperature sensor, an audio sensor, a motion detector, a weight sensor, a moisture sensor, a calendar data interface device, an electrical transmission detector, a timer, a news event monitor, a meteorological sensor device, and any combinations thereof.

10. The method of claim 7, further comprising determining whether the predetermined type of event is associated with the electronic file.

11. The method of claim 7, wherein the predetermined event is at least one event selected from the group consisting of a sound, a sequence of sounds, a temperature, a time, a date, a news event, a message, a meteorological event, a presence of a person or animal, and any combinations thereof.

12. A method comprising:
monitoring a local vicinity of a memory capture device for an occurrence of a threshold physical event;
detecting the occurrence of the threshold physical event; and
automatically capturing and storing information from the local vicinity of the capture device in an electronic file in response to the detecting, the electronic file including at least one of image, video, and audio data types.

13. The method of claim 12, further comprising substantially concealing the memory capture device in an inanimate object.

14. The method of claim 12, wherein said capture device comprises a camera device, an audio recording device, and combinations thereof.

15. The method of claim 12, wherein the threshold physical event comprises a motion in the local vicinity, a sound in the local vicinity, a temperature change in the local vicinity, and combinations thereof.

16. The method of claim 12, wherein the inanimate object comprises a furniture, a toy, and a stuffed animal.

17. A method comprising:
monitoring a local vicinity of a memory capture device for a presence of a physical object or an occurrence of a threshold physical event;
detecting the presence of the physical object or the occurrence of the threshold physical event; and
automatically capturing and storing information from the local vicinity of the capture device in an electronic file, wherein the electronic file includes at least one of image, video, and audio data types and the capture device includes a camera device.

18. The method of claim 17, further comprising presenting the electronic file.

19. The method of claim 17, wherein the camera device comprises a charge coupled device (CCD).

20. The method of claim 17, wherein the capture device comprises a motion sensor.

21. A system comprising:
a capture device including a camera device;
a processor;
a memory operatively coupled to the processor and storing executable instructions to control the processor to:
monitoring a local vicinity of the capture device for a presence of a physical object or an occurrence of a threshold physical event;
detecting the presence of the physical object or the occurrence of the threshold physical event; and
automatically capturing and storing information from the local vicinity of the capture device in an electronic file, wherein the electronic file includes at least one of image, video, and audio data types.

22. The system of claim 21 wherein the camera device comprises a motion sensor.
